(19) United States
(12) Patent Application Publication
(10) Pub. No.: US 2013/0004395 A1
(43) Pub. Date: Jan. 3, 2013

(54) PROCESSES AND APPARATUSES FOR OXIDIZING ELEMENTAL MERCURY IN FLUE GAS USING OXYCHLORINATION CATALYSTS

(75) Inventors: Melanie Timmons Schaal, Schaumburg, IL (US); Robert L. Bedard, McHenry, IL (US)

(73) Assignee: UOP LLC, Des Plaines, IL (US)

(21) Appl. No.: 13/174,190

(22) Filed: Jun. 30, 2011

(51) Int. Cl. B01D 53/64; B01D 53/56

(52) U.S. Cl. 423/235; 423/210; 422/177; 422/171

(57) ABSTRACT

Processes for decreasing elemental mercury in flue gas stream are provided. The processes include receiving the flue gas stream containing elemental mercury in an oxidation zone and maintaining the oxidation zone at a temperature of less than about 200° C. In the oxidation zone, the flue gas stream is contacted with an oxychlorination catalyst. As a result, the elemental mercury is oxidized to create oxidized mercury in an oxidized flue gas. The oxidized mercury is then removed from the oxidized flue gas.

### FIELD OF THE INVENTION

The present invention generally relates to processes and apparatuses for processing flue gas, and more particularly relates to processes and apparatuses for decreasing elemental mercury in flue gas.

### BACKGROUND OF THE INVENTION

Coal-fired power plants are a significant source of hazardous air pollutants. While arsenic, chromium, lead, and nickel comprise appreciable hazardous air pollutants released from coal power plants, elemental mercury is many orders of magnitude more toxic than these other pollutants. Further, coal is currently burnt in very large volumes for power generation. As a result, burning coal is the largest single anthropogenic source of mercury air emissions.

After emission to the environment from coal-fired power plants, elemental mercury generally settles in lakes and rivers and moves up the food chain from microorganisms to larger fish and shellfish consumed by humans. Mercury consumption is known to impair neurological development in fetuses, infants and children. Accordingly, mercury is now recognized by the World Health Organization and the United Nations Environmental Program as a global threat to human health and the environment.

In response to the growing threat of mercury pollution, Canada endorsed limits for mercury emissions in 2000. Then, the United Nations Environment Program formed a Global Mercury Partnership to protect human health and the global environment from the release of mercury and its compounds by minimizing and, where feasible, ultimately eliminating global, anthropogenic mercury releases to the environment. The United States Environmental Protection Agency has now set limits for future mercury emissions from coal-fired and oil-fired power plants.

Currently, the main elemental mercury removal mode involves the injection of bromine-treated powdered activated carbon into the flue gas stream, for mercury adsorption with subsequent removal in a particulate collector. Alternative methods have included the modification of existing selective catalytic reduction (SCR) units to run at conditions that maximize oxidation of elemental mercury, followed by its removal in the flue gas desulfurization (FGD) unit. However, such SCR conditions typically result in increased formation of sulfur trioxide, a significant pollutant and the primary agent in acid rain.

Accordingly, it is desirable to provide a process and apparatus for decreasing elemental mercury in a flue gas at safe conditions. Also, it is desirable to provide a process and apparatus that decreases mercury from a flue gas without forming other pollutants. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Processes and apparatuses for decreasing elemental mercury in flue gas streams are provided. In accordance with one embodiment, a process includes receiving the flue gas stream containing elemental mercury in an oxidation zone and maintaining the oxidation zone at a temperature of less than about 200° C. In the oxidation zone, the flue gas stream is contacted with an oxychlorination catalyst, which catalyzes the formation of chlorine gas from hydrogen chloride contained in the flue gas. Thereafter, the elemental mercury is oxidized by the chlorine gas to create oxidized mercury in the flue gas stream. The oxidized mercury is then removed from the flue gas stream in a flue gas desulfurization (FGD) unit.

In another embodiment, a process for decreasing elemental mercury from a flue gas stream comprises providing a catalytic oxidation chamber having an inlet and an outlet and defining an oxidation zone. Further, the process positions an oxychlorination catalyst in the oxidation zone and maintains the oxidation zone at a temperature of less than about 200° C. The flue gas stream containing hydrogen chloride gas and elemental mercury vapor is fed to the oxidation zone through the inlet of the chamber. In the oxidation zone, the flue gas stream is contacted with the oxychlorination catalyst. In accordance with the embodiment, the elemental mercury is oxidized to create oxidized mercury in an oxidized flue gas. The oxidized flue gas is then removed from the chamber through the outlet.

An apparatus for decreasing elemental mercury in a flue gas stream in accordance with a further embodiment comprises a catalytic oxidation chamber inlet configured to receive the flue gas stream containing elemental mercury. The apparatus further includes an oxidation zone maintained at a temperature of less than about 200° C. for holding an oxychlorination catalyst configured to oxidize the elemental mercury to create oxidized mercury in an oxidized flue gas when the flue gas stream is contacted with the oxychlorination catalyst. Also, the apparatus is provided with a catalytic oxidation chamber outlet configured to remove the oxidized mercury and the oxidized flue gas from the oxidation zone.

### BRIEF DESCRIPTION OF THE DRAWINGS

The present invention will hereinafter be described in conjunction with the following drawing figures, wherein like numerals denote like elements, and wherein:

FIG. 1 is a schematic depiction of an apparatus for decreasing elemental mercury in a flue gas stream in accordance with an exemplary embodiment; and

FIG. 2 is a schematic depiction of an apparatus for decreasing elemental mercury in a flue gas stream in accordance with another exemplary embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Processes and apparatuses for decreasing elemental mercury in flue gas using an oxychlorination catalyst are provided herein. The oxychlorination catalyst is positioned in an oxidation zone and provides for removing elemental mercury through two different mechanisms. First, when flue gas containing elemental mercury contacts the oxychlorination catalyst in the oxidation zone, the catalyst causes an oxidation reaction converting a portion of the elemental mercury to oxidized mercury. The highly water soluble oxidized mercury can then be removed from the flue gas with a wet scrubber or similar device. Second, a portion of the elemental mercury in the flue gas is adsorbed onto the surface of the oxychlorination catalyst in the oxidation zone. This adsorbed mercury can be mechanically removed from the catalyst and safely eliminated. In order to minimize the formation of sulfur trioxide from the sulfur dioxide in the flue gas, the oxidation zone is maintained at a temperature of less than about 200° C. As a result, the elemental mercury elimination process reduces the formation of sulfur trioxide by at least 50% compared to higher temperature operations.

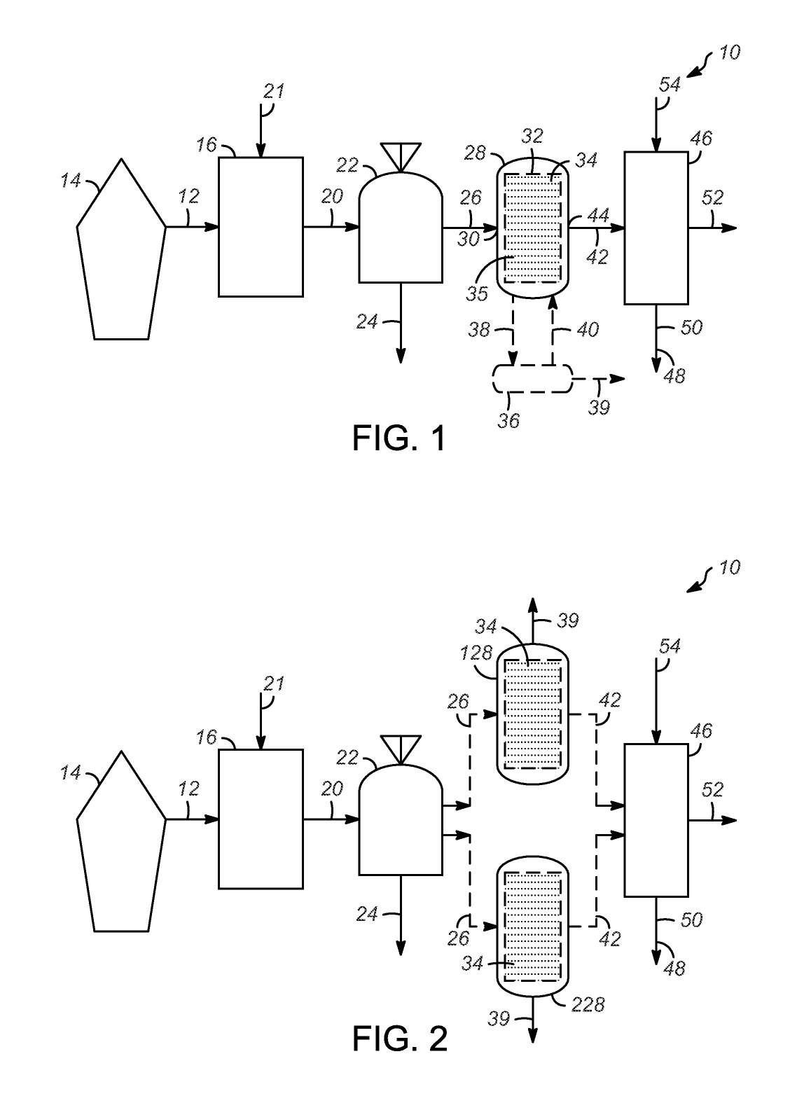

In accordance with an exemplary embodiment, FIG. 1 is a schematic illustration of an apparatus 10 for decreasing elemental mercury in an industrial waste stream 12, such as a flue gas, created from an industrial waste source 14. Typically, the flue gas 12 is created from combustion of coal, oil, or other fossil fuel and contains elemental mercury, oxidized mercury, nitrogen oxides, sulfur dioxide, particulate matter such as fly ash, and hydrogen chloride gas, among other constituents.

As shown in FIG. 1, the flue gas 12 created from the industrial waste source 14 is fed to a selective catalytic reduction unit 16. For purposes of the exemplary embodiment, the selective catalytic reduction unit 16 reduces nitrogen oxides (NOₓ) in the flue gas 12 and can be considered to create a reduced flue gas 20. In an embodiment, the exemplary selective catalytic reduction unit 16 is run at elevated temperatures of between 300° C. and 400° C. As shown, the selective catalytic reduction unit 16 may add a gaseous reductant 21, such as anhydrous ammonia, aqueous ammonia or urea, to the flue gas 12. Within the selective catalytic reduction unit 16, the nitrogen oxides, the reductant 21, and oxygen are converted over the catalyst to nitrogen and water. Preferably, levels of nitrogen oxides in the flue gas 12 are reduced by at least 90% by the selective catalytic reduction unit 16.

The reduced flue gas 20 is fed to a particulate collector 22, such as a baghouse, electrostatic precipitator, inertial separator, fabric filter or other known device. At the particulate collector 22, particulate matter 24 such as fly ash, along with pollutants or toxins adsorbed on the particulate matter 24, is removed from the reduced flue gas 20 producing a flue gas stream 26.

After leaving the particulate collector 22, the flue gas stream 26 is introduced to a catalytic oxidation chamber 28 through an inlet 30. As shown, the catalytic oxidation chamber 28 defines an oxidation zone 32. Preferably, the flue gas stream 26, catalytic oxidation chamber 28, and oxidation zone 32 are maintained at a temperature not exceeding about 200° C. More preferably, the flue gas stream 26, catalytic oxidation chamber 28, and oxidation zone 32 are maintained at a temperature from about 140° C. to about 160° C. Most preferably, the flue gas stream 26, catalytic oxidation chamber 28, and oxidation zone 32 are maintained at a temperature of about 150° C. In the illustrated embodiment, no heaters or heat exchangers are necessary to maintain the desired temperature, as the flue gas stream 26 will cool from its elevated temperature in the selective catalytic reduction unit 16 to about 150° C. when it enters the catalytic oxidation chamber 28.

In FIG. 1, an oxychlorination catalyst 34 is positioned in the oxidation zone 32. For purposes of the exemplary embodiment, the oxychlorination catalyst 34 is copper-based. More particularly, the oxychlorination catalyst 34 includes copper chloride, magnesium chloride, and potassium chloride deposited on an alumina. Alternatively or additionally, the oxychlorination catalyst may include other chloride compounds such as lanthanum (III) chloride (LaCl₃). In an exemplary embodiment, the oxychlorination catalyst comprises about 6.0% copper chloride, about 1.7% magnesium chloride, and about 0.5% potassium chloride. As shown in FIG. 1, the oxychlorination catalyst 34 is positioned in a fixed bed arrangement either in a granular packed bed or in a monolithic or honeycomb form, although a moving bed or other arrangement could be utilized. In certain embodiments, a honeycomb form of the catalyst 34 will have four channels per inch in order to optimize surface per unit volume.

Generally, the oxychlorination reaction is:

Hg^{o}+2HCl+0.5O₂→HgCl₂+H₂O

Because the flue gas stream 26 contains hydrogen chloride gas and oxygen, contact of the flue gas stream 26 with the oxychlorination catalyst 34 in the oxidation zone 32 initiates the oxychlorination reaction. As a result, chlorine gas and water are formed. Further reactions between the elemental mercury and the chlorine gas supplied by the oxychlorination reaction and chloride gas result in the oxidation of a portion of the elemental mercury to forms of oxidized mercury, such as mercuric chloride (HgCl₂), an oxidized mercury salt highly soluble in water. In certain embodiments, a second catalyst 35 active in mercury oxidation may be positioned in the oxidation zone. For example, the second catalyst 35 may be a supported catalyst comprising one or more metals from group VIII or the noble metals of the periodic table. Alternatively, a metal oxide or mixed metal oxide with activity for mercury oxidation can be utilized either self-supported or provided on a refractory metal oxide support.

The following mercury oxidation reactions may occur in the oxidation zone 32:

2Hg⁰+O₂→2HgO

Hg⁰+Cl₂→HgCl₂

2Hg⁰+Cl₂→2Hg₂Cl₂

Hg⁰+2HCl→HgCl₂+H₂

2Hg⁰+4HCl+O₂→2HgCl₂+H₂O

4Hg⁰+4HCl+O₂→2Hg₂Cl₂+H₂O

Hg⁰+NO₂→HgO+NO

In addition to the oxidation of a portion of the elemental mercury initiated by the oxychlorination reaction, another portion of the elemental mercury may be removed from the flue gas stream 26 by adsorption. Specifically, elemental mercury contacting the oxychlorination catalyst 34 is adsorbed on the surface of the oxychlorination catalyst 34. The adsorption of elemental mercury on the oxychlorination catalyst 34 may occur before and/or during the oxychlorination reaction. In an exemplary embodiment, the adsorbed mercury can be removed from the catalyst 34 during downtime along with other deposits on the catalyst surface, such as ash. In an alternate embodiment, the adsorbed mercury can be removed from the flue gas stream 26 by a catalyst regenerator 36. As shown in FIG. 1, in this alternate embodiment, dirty oxychlorination catalyst 38 is removed from the catalytic oxidation chamber 28 and delivered to the regenerator 36. In the regenerator 36, the deposits 39 including ash and possibly adsorbed mercury is removed and disposed of, and clean oxychlorination catalyst 40 is returned to the catalytic oxidation chamber 28. Further, a second catalyst regenerator (not shown) may be provided to regenerate the second catalyst 35.

As a result of the oxidation of a portion of the elemental mercury and the adsorption of a portion of the elemental mercury onto the oxychlorination catalyst 34 in the oxidation zone 32, at least 80% of elemental mercury may be removed from the flue gas stream 26. In exemplary embodiments, 90% of elemental mercury may be removed from the flue gas stream 26. More preferably, at least 95% of elemental mercury is removed from the flue gas stream 26. Most preferably, at least 99% of elemental mercury is removed from the flue gas stream 26. With the removal of elemental mercury from the flue gas stream 26, the catalytic oxidation chamber 28 can be considered to create an oxidized flue gas 42.

As shown in FIG. 1, the oxidized flue gas 42 exits the catalytic oxidation chamber 28 via an outlet 44. Thereafter, the oxidized flue gas 42 is fed to a flue gas desulfurization unit 46, such as a wet scrubber. In the flue gas desulfurization unit 46, sulfur dioxide 48 and oxidized mercury 50 are separated and removed from the oxidized flue gas 42 creating a scrubbed flue gas 52. Specifically, a water stream containing calcium carbonate or calcium hydroxide 54 is brought into contact with the oxidized flue gas 42. Water soluble compounds in the oxidized flue gas 42, including oxidized mercury 50 and sulfur dioxide 48, are dissolved into the water and exit the flue gas desulfurization unit 46 in a liquid stream. The scrubbed flue gas 52 may then be safely emitted into the air.

While the illustrated apparatus 10 includes its components in a defined sequence, other embodiments may include alternate arrangements. For instance, the particulate collector 22 may be positioned downstream of the catalytic oxidation chamber 28. However, the arrangement illustrated in FIG. 1 is preferred. In the illustrated embodiment, the industrial waste source 14 is shown connected directly to the selective catalytic reduction unit 16. Typically, the industrial waste source 14 is a power plant, chlor-alkili plant, cement plant, or incinerator. Therefore, the flue gas 12 is generally at an elevated temperature, for instance, above 300° C. For the illustrated apparatus 10, the temperature of the flue gas stream 26 after passing through the selective catalytic reduction unit 16 and the particulate collector 22 is about 150° C. Therefore, the illustrated arrangement of components reduces heat costs as the flue gas stream 26 need not be heated or cooled for appropriate contact with the oxychlorination catalyst 34 in the oxidation zone 32. Further, maintaining the oxidation zone 32 at the reduced temperature prevents or decreases the formation of sulfur trioxide during the oxidation of elemental mercury.

Referring to FIG. 2, an alternate embodiment of the apparatus is shown. In FIG. 2, the apparatus 10 is provided with a first catalytic oxidation chamber 128 and second catalytic oxidation chamber 228. Further, the catalytic oxidation chambers 128, 228 are shown to be connected in parallel downstream of the particulate collector 22 and upstream from the flue gas desulfurization unit 46. As a result, catalytic regeneration can occur off line. Specifically, in a first configuration the first catalytic oxidation chamber 128 may be operationally connected to receive the flue gas stream 26 from the particulate collector 22 and to deliver oxidized flue gas 42 to the flue gas desulfurization unit 46. In a second configuration, the second catalytic oxidation chamber 228 may be operationally connected to receive the flue gas stream 26 from the particulate collector 22 and to deliver oxidized flue gas 42 to the flue gas desulfurization unit 46.

When the oxychlorination catalyst 34 in the first catalytic oxidation chamber 128 is spent or coated with particulate material 24 such as adsorbed mercury or ash, the first catalytic oxidation chamber 128 may be isolated from the apparatus 10, and the second catalytic oxidation chamber 228 may be operationally connected. Thereafter, the oxychlorination catalyst (and second catalyst 35) may be regenerated in the first catalytic oxidation chamber 128 and particulate material 24 such as adsorbed mercury 39 removed. Likewise, when the oxychlorination catalyst 34 in the second catalytic oxidation chamber 228 is spent or coated with adsorbed mercury or ash, the second catalytic oxidation chamber 228 may be isolated from the apparatus 10, and the first catalytic oxidation chamber 128 may be operationally connected. Thereafter, the oxychlorination catalyst (and second catalyst 35) may be regenerated in the second catalytic oxidation chamber 228 and particulate material including adsorbed mercury 39 removed. This arrangement is particularly appropriate for a fixed bed catalyst system.

### EXAMPLES

Mercury oxidation was evaluated in a system composed of inert wetted components (e.g. PFA, glass, etc.). The feed stream contained about 20 parts per million (ppm) HCl, 250 ppm SO₂, 70-80 micrograms (μg) Hg/Nm³, 6% O₂, 16% CO₂, and balance N₂. The gas flows were set to achieve a feed slip stream flow of about 75 standard cubic centimeters per minute (sccm) and a flow through the reactor of about 300 sccm. The reactor pressure was controlled at about 8 pounds per square inch (psig) using a back pressure regulator. The reactor temperature was maintained at 150° C.

A ⅛ inch perfluoroalkoxy (PFA) reactor was used in order to achieve a high superficial velocity. Additionally, in order to achieve a high gas hourly space velocity (GHSV) and sustain a reasonable reaction time for the screening process, only up to 0.037 cubic centimeters (cm³) (typically about 0.02 g, 25 mm bed length, reactor internal diameter of 1.38 mm) of 40×60 mesh sample was loaded into the reactor. An Ohio Lumex RA-915⁺ mercury analyzer that uses differential Zeeman atomic adsorption and only responds to elemental Hg (not oxidized Hg) was used to quantify the concentration of Hg in both the feed and effluent streams. In order to verify that the low concentration of elemental Hg detected in the product stream was indeed due to Hg oxidation, the feed and effluent streams were passed through ‘solid traps’ (typically containing about 0.52 wt % Pd/DiaFil (diatomaceous earth)) that adsorbed both the elemental and oxidized Hg. These ‘solid traps’ were then evaluated ex-situ using a Nippon Instruments Hg analyzer (cold vapor atomic absorption) to determine the total (oxidized+elemental) Hg content.

### Example I

Example I illustrates that a CuCl₂ based oxychlorination catalyst is effective for Hg oxidation at 150° C. The previously described experimental conditions and instrumentation were used. A 6.76 wt % Cu, 1.87 wt % Mg, 0.67 wt % K/Al₂O₃ catalyst was prepared using conventional incipient wetness impregnation of MgCl₂, CuCl₂, and KCl on a 250 m²/g gamma Al₂O₃. The sample was dried at 70° C. then calcined at 150° C. for 1 hour. Comparison of the feed and effluent elemental Hg readings showed that after being on stream more than 8,000 minutes, the Hg was still only at about 35% breakthrough (feed gas stream contained SO₂, CO₂, O₂, Hg, and N₂). At about 11,000 minutes on stream, 20 ppm v HCl was added to the system. The elemental Hg concentration decreased to nearly zero indicating greater than 95% apparent Hg oxidation. Ex-situ analysis of samples drawn just before the reaction was terminated at about 15,500 minutes on stream confirmed that Hg oxidation was still greater than 95%.

### Example II

Example II illustrates that when the CuCl₂ loading is drastically reduced, the oxychlorination catalyst is still effective for Hg oxidation at 150° C. The previously described experimental conditions and instrumentation were used. A 1.01 wt % Cu, 0.25 wt % Mg, 0.11 wt % K/Al₂O₃ catalyst was prepared using the same procedure as noted previously. After being on stream about 4,300 minutes in the absence of HCl, the elemental Hg concentrations in the feed and effluent streams were still not equal (feed gas stream contained SO₂, CO₂, O₂, Hg, and N₂). Ex-situ analysis of samples drawn at this time indicated that greater than 60% of the Hg in the feed stream was being oxidized even before HCl was added to the system. At about 4,360 minutes the simulated flue gas (CO₂, SO₂, and O₂) was removed and replaced with N₂. The elemental Hg concentration in the effluent stream increased sharply. When the simulated flue gas (CO₂, SO₂, and O₂) was re-introduced to the system at about 5,300 minutes, the elemental Hg concentration in the effluent stream decreased sharply suggesting that oxygen is involved in the Hg oxidation reaction. At about 5,600 minutes on line about 20 ppm v HCl was added to the feed stream; the effluent elemental Hg concentration as measured by the Ohio Lumex detector (which only detects elemental mercury) showed that the apparent Hg oxidation was greater than 95%. Ex-situ analysis of samples drawn at 9,900 minutes confirmed that Hg oxidation was greater than 90%.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A process for decreasing elemental mercury in a flue gas stream, the process comprising:
receiving the flue gas stream containing elemental mercury in an oxidation zone;
maintaining the oxidation zone at a temperature of less than about 200° C.;
contacting the flue gas stream with an oxychlorination catalyst in the oxidation zone;
oxidizing the elemental mercury in the flue gas stream to create oxidized mercury in an oxidized flue gas; and
removing the oxidized mercury from the oxidized flue gas.

2. The process of claim 1 wherein during the oxidizing step, hydrogen chloride gas is converted into chorine gas and the chlorine gas oxidizes the elemental mercury, and wherein the hydrogen chloride gas is supplied within the flue gas stream.

3. The process of claim 1 wherein the oxychlorination catalyst is copper-based.

4. The process of claim 3 wherein the oxychlorination catalyst comprises copper chloride, magnesium chloride, and potassium chloride deposited on an alumina.

5. The process of claim 4 wherein the oxychlorination catalyst comprises about 6.0% copper chloride, about 1.7% magnesium chloride, and about 0.5% potassium chloride.

6. The process of claim 5 wherein the oxidation zone is maintained at a temperature of about 150° C.

7. The process of claim 6 further comprising:
reducing nitrogen oxide in a flue gas to create a reduced flue gas;
removing particulate matter from the reduced flue gas to create the flue gas stream; and
removing oxidized mercury and sulfur dioxide from the oxidized flue gas.

8. The process of claim 7 wherein a first portion of the elemental mercury is oxidized, the process further comprising adsorbing a second portion of the elemental mercury onto the oxychlorination catalyst.

9. A process for decreasing elemental mercury in a flue gas stream, the process comprising:
providing a catalytic oxidation chamber having an inlet and an outlet and defining an oxidation zone;
positioning an oxychlorination catalyst in the oxidation zone;
maintaining the oxidation zone at a temperature of less than about 200° C.;
feeding the flue gas stream to the oxidation zone through the inlet;
contacting the flue gas stream with the oxychlorination catalyst in the oxidation zone;
oxidizing the elemental mercury to create oxidized mercury in the flue gas stream; and
removing the flue gas stream from the chamber through the outlet.

10. The process of claim 8 further comprising:
providing a selective catalytic reduction unit, a particulate collector, a flue gas desulfurization unit, and a catalyst regenerator;
feeding a flue gas to the selective catalytic reduction unit;
reducing nitrogen oxides in the flue gas in the selective catalytic reduction unit to create a reduced flue gas;
feeding the reduced flue gas to the particulate collector;
removing particulate matter from the reduced flue gas in the particulate collector to create the flue gas stream;
feeding the oxidized flue gas to the flue gas desulfurization unit; and
removing the oxidized mercury and sulfur dioxide from the oxidized flue gas in the flue gas desulfurization unit.

11. The process of claim 10 wherein, during the oxidizing step, hydrogen chloride gas is converted into chlorine gas and the chlorine gas oxidizes the elemental mercury, and wherein the hydrogen chloride gas is supplied within the flue gas stream.

12. The process of claim 11 wherein the oxychlorination catalyst is copper-based.

13. The process of claim 12 wherein the oxychlorination catalyst comprises copper chloride, magnesium chloride, and potassium chloride deposited on an alumina.

14. The process of claim 13 wherein the oxychlorination catalyst comprises about 6.0% copper chloride, about 1.7% magnesium chloride, and about 0.5% potassium chloride.

15. The process of claim 14 wherein the oxidation zone is maintained at a temperature of about 140° C. to about 160° C.

16. The process of claim 15 wherein the oxidation zone is maintained at a temperature of about 150° C.

17. An apparatus for decreasing elemental mercury in a flue gas stream, the apparatus comprising:
a catalytic oxidation chamber inlet configured to receive the flue gas stream containing elemental mercury;
an oxidation zone maintained at a temperature of less than about 200° C. for holding an oxychlorination catalyst configured to oxidize the elemental mercury to create oxidized mercury in an oxidized flue gas when the flue gas stream is contacted with the oxychlorination catalyst; and
a catalytic oxidation chamber outlet configured to remove the oxidized mercury and the oxidized flue gas from the oxidation zone.

18. The apparatus of claim 17 wherein the oxidation zone is configured to be maintained at a temperature of about 150° C.

19. The apparatus of claim 17 further comprising:
a selective catalytic reduction unit configured for reducing nitrogen oxide in a flue gas to create a reduced flue gas; and
a particulate collector configured for removing particulate matter from the reduced flue gas to create the flue gas stream.

20. The apparatus of claim 19 further comprising a flue gas desulfurization unit configured for removing the oxidized mercury and sulfur dioxide from the oxidized flue gas.
